(19) United States
(12) Patent Application Publication
(10) Pub. No.: US 2003/0125843 A1
(43) Pub. Date: Jul. 3, 2003

(54) Heating, cooling and power configuration and management system

(76) Inventor: P.V.K. Prasad, Maharashtra (IN)

Correspondence Address: JOHN W. REES, DYKEMA GOSSETT PLLC, SUITE 300, 39577 WOODWARD AVENUE, BLOOMFIELD HILLS, MI, 48304-5086, US

(21) Appl. No.: 10/306,413

(22) Filed: Nov. 27, 2002

Related U.S. Application Data
(60) Provisional application No. 60/333,869, filed on Nov. 28, 2001.

(51) Int. Cl. G06F 17/00

(52) U.S. Cl. 700/291; 700/90

(57) ABSTRACT

A computer-implemented system is adapted to generate an energy scheme that includes power, heating and/or cooling equipment. The system includes a relational database, and generates the energy scheme for a facility based on geographic data, facility specific data, an energy demand profile for the facility including at least a power component, whether there is a cogeneration equipment requirement, a user selected primary technology option, and a user-selected system type. The output energy scheme is generated in multiple options configured for a plurality of different demand situations, such as a situation that considers the energy needed to meet the facility's maximum energy demand, to meet the facility's minimum energy demand, and the like. The energy schemes that meet the technical requirements are also validated for compliance with geographic-specific regulations. The system further includes a module for generating an economic analysis of the energy schemes.

### RELATED APPLICATIONS

This application claims the benefit of U.S. provisional application Serial No. 60/333,869 filed Nov. 28, 2001, hereby incorporated by reference in its entirety.

### BACKGROUND OF THE INVENTION

1. Technical Field

The present invention is related generally to a computer-implemented system and method for selecting equipment for an energy scheme, and, more particularly, the selection of power, heating and cooling equipment.

2. Description of the Related Art

Historically, commercial and residential energy consumers obtained their power requirements from a local power grid, which is conventionally supplied by large, centrally located, stationary electrical power generators. In recent times, however, a number of factors have caused a reassessment of this traditional approach. In particular, these factors include the concern with the emission of greenhouse gases from the above-mentioned large, stationary power generators, energy sector deregulation, the growing need for power in developing countries not served by well-developed power grids, and the natural interests across all sectors to improve efficiency with respect to their power consumption (i.e., obtaining quality energy at the lowest possible cost). The foregoing factors have led to the development of distributed generation (DISGEN) power alternatives which are co-located and/or associated closely with the power consumer's location. In addition to electricity, nearly all commercial and residential facilities require heating and/or cooling to some extent or another. A particular implementation referred to as combined heat and power (CHP) is known, sometimes also referred to as cogeneration, operates at increased efficiencies (i.e., sometimes at efficiencies greater than 70%), while emitting less carbon dioxide compared to conventional coal-fired power generation units that power electrical grids. CHP schemes are also available that provide cooling as well.

Heretofore, configuring a distributed generation system for a facility involved assessment of a very large number of factors including but not limited to the availability of fuels, prevailing ambient temperatures, regulations applying to the geographic location of the facility, the specific power, heating and cooling loads expected at the facility, whether there are any cogeneration requirements for the facility, the overall economics, and whether any subsystems are necessary. Traditionally, this analysis was performed manually and involved an individual spending, for example, a day to investigate the demand profile, as well as other data, another day to compile the raw data into an energy demand report, still another day to come up with an initial system solution as well as options. The foregoing solution, of course, varied on a per individual basis, and was experience dependent. Still further time was involved in checking the validity of proposed design configuration against prevailing regulatory guidelines. Further time was required to assemble a proposed commercial offer that would include necessary subsystems. The foregoing involves technical and regulatory compliance. If the customer wanted an economic analysis, still further time was required to conduct an economic feasibility study. In sum, the conventional approach required many man-days to prepare, and was characterized by an undesirable amount of variation in quality (i.e., individual dependent). There are thus many shortcomings in the art.

As to the known literature, one approach involves an automated system for the selection of heating equipment, as seen by reference to U.S. Pat. No. 6,167,388 entitled “SYSTEM AND METHOD FOR THE SELECTION OF HEATING EQUIPMENT” issued to Ray. Ray discloses an automated system for specifying radiant tube heating systems. The automated specification system calculates the heat loss for a structure and adjusts the heat loss value according to deviations from standard radiant heating system installations. The specification system of Ray provides the user with burner and tube layout parameters in conjunction with an input menu for receiving the accessory equipment inputs of the radiant tube heating system. Ray further discloses that the specification system retrieves equipment specifications from a product database in response to user inputs and presents the user with a complete specification package for the specified radiant tube heating system. However, Ray does not purport to address the power and cooling needs of a user at all, nor, obviously, how a comprehensive solution for power, heating and cooling can be determined.

Accordingly, there is still a need for an improved system for power, heating and cooling equipment configuration that minimizes or eliminates one or more of the problems as set forth above.

### SUMMARY OF THE INVENTION

One object of the present invention is to minimize or eliminate one or more of the problems as set forth above. The invention involves a computer-implemented system and method that automates data collection needed for configuring power, heating and cooling equipment, and is coupled to a central database, substantially reducing the amount of time to arrive at a distributed generation solution for a particular facility. In addition, the inventive system delivers a uniform and improved quality output unavailable through the use of conventional approaches. Moreover, the invention comprehensively addresses both technical and economic considerations of a proposed power, heating and cooling system.

These and other advantages, objects and features are realized by a method of determining an energy scheme that includes three basic steps. The first step involves inputting an energy demand profile for a facility wherein the profile includes at least a power component. Next, selecting a system type to be configured. In one embodiment, the system type is indicative of the type of equipment to be configured and is a power generation option selected from the group comprising (i) power; (ii) power and heating; (iii) power and cooling; and (iv) power, heating and cooling. Finally, the third step involves determining at least one energy scheme using the energy demand profile in accordance with the selected system type. In a preferred embodiment, at least one energy scheme is configured for and corresponds to one of a plurality of demand situations. The demand situations may include (i) a maximum demand situation, (ii) a minimum demand situation, (iii) a critical demand situation, (iv) an optimal demand situation, (v) a cogeneration demand situation, and (vi) a grid parallel-based demand situation.

In a preferred embodiment, a method of determining a primary energy scheme includes several steps. First, selecting a geographic location for a facility for which equipment is to be configured. Next, inputting an energy demand profile as a function of time for the facility that includes at least a power demand component. Next, selecting a primary technology for the primary energy scheme. For example, the primary technology may involve diesel equipment, natural gas-based equipment, etc. Next, selecting a system type, as described above. Finally, determining the primary energy scheme based on the selected geographic location, the energy demand profile, selected primary technology, and the selected system type.

In an alternate embodiment, the method further includes the step of inputting implied costs associated with the primary energy scheme. The implied costs may be, for example, necessary supplemental, or mitigation (pollutants) equipment, as required. In still yet a further embodiment, the method includes the step of calculating a value proposition output that includes at least a total capital cost and a total operating cost for the primary energy scheme, which takes into account the implied costs. The value proposition output represents an economic view of the energy scheme. In a still further embodiment, the data corresponding to the primary energy scheme and the value proposition output is sent from a server computer over a network to a remote client computer.

An apparatus that is configured to perform the above-described method is also presented.

Other objects, features, and advantages of the present invention will become apparent to one skilled in the art from the following detailed description and accompanying drawings illustrating features of this invention by way of example, but not by way of limitation.

### BRIEF DESCRIPTION OF THE DRAWINGS

The present invention will now be described by way of example, with reference to the accompanying drawings, in which:

FIG. 1 is a simplified block diagram of a stand alone, a networked, and a web-enabled embodiment of the present invention.

FIG. 2 is a simplified block diagram view showing the layers of the architecture of the present invention.

FIG. 3 is a simplified block and flow diagram view of the operation of a preferred embodiment.

FIG. 4 is a screen display of a facility type input interface of the preferred embodiment.

FIG. 5 is a screen display of a utility provider input interface of the preferred embodiment.

FIGS. 6-7 are screen displays of a simple power demand profile interface of the preferred embodiment.

FIG. 8 is a screen display of a detailed power demand profile of the preferred embodiment.

FIG. 9 is a screen display showing an interface configured to obtain cogeneration requirements of the preferred embodiment.

FIG. 10 is a screen display showing an interface configured to obtain a primary technology from a user.

FIG. 11 is a screen display showing an output of the preferred embodiment, namely multiple energy schemes (options) configured for and corresponding to a plurality of different demand situations.

FIG. 12 is a screen display showing, in greater detail, an energy scheme selected from the multiple energy schemes in FIG. 11.

FIG. 13 is a screen display showing an interface configured to input implied costs for economic analysis.

FIG. 14 is a screen display showing an interface configured to input implied benefits.

FIG. 15 is a simplified block and flow diagram showing a methodology for calculating a value proposition output for multiple energy schemes.

FIG. 16 is a screen display showing a value proposition output for a primary and a competing energy scheme configured for and corresponding to a plurality of different demand situations.

FIG. 17 is a simplified flow chart diagram showing a method for determining various life cycle cost analyses.

FIG. 18 is a screen display showing a life cycle cost analysis (LCCA) for a primary and competing energy scheme each configured for and corresponding to one or more demand situations.

### DETAILED DESCRIPTION OF THE PREFERRED EMBODIMENTS

The present invention provides a system and method for configuring distributed generation solutions for a facility. The invention provides the means for analyzing energy needs, mapping the needs with available equipment technologies, and presenting a variety of options. In addition to a configuration meeting technical requirements, the invention is also configured to provide economic-based outputs, such as a life cycle cost analysis, to guide the user in making the most optimal energy infrastructure decisions. The invention dramatically reduces the manpower cost in arriving at power, heating and cooling solutions, improves the uniformity of the solutions, as well as improves productivity.

Before proceeding to a detailed description of the functionality of the invention, however, a general overview will be set forth.

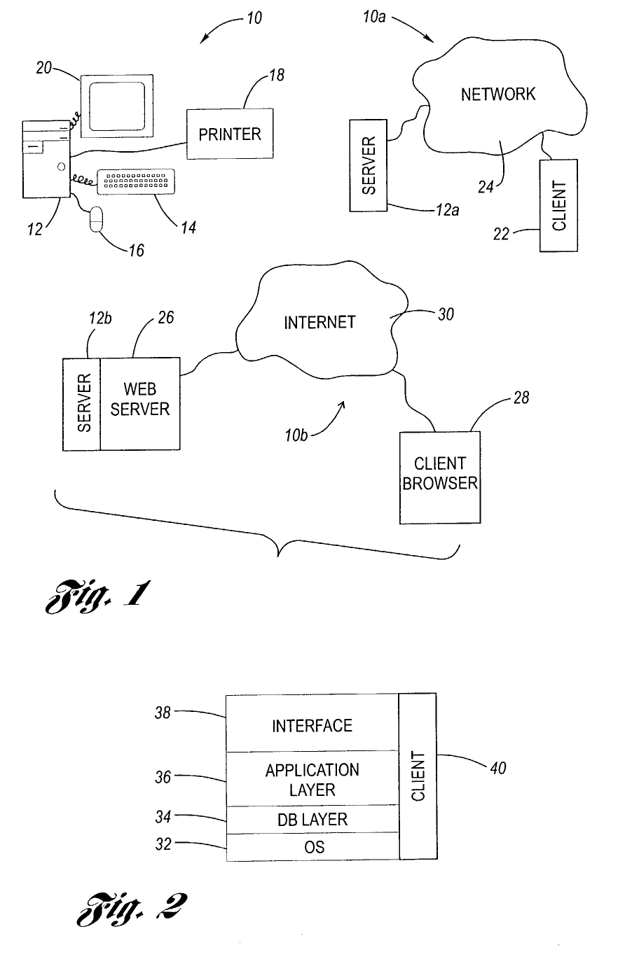

Referring now to the drawings wherein like reference numerals are used to identify identical components in the various views, FIG. 1 is a simplified block diagram view showing a stand alone system 10, a networked system 10a, and a web-enabled system 10b according to the present invention. System 10 for performing the method of the present invention includes a central processing unit 12, with conventional keyboard 14, a mouse 16, an output device such as a printer 18, and a display such as a monitor 20. The stand alone system 10 may likewise comprise a portable, notebook computer. System 10 is particularly suited for dealers, and field engineers who require, for example, portability. System 10a is a networked embodiment including a server 12a, a client 22 and a network 24. System 10a (client-server embodiment) is particularly suited for large organizations using client servers over the internal company network. System 10b is a web-server embodiment that includes a server 12b according to the invention, coupled to a conventional web server 26 that would communicate to a remote client browser 28 over internet 30.

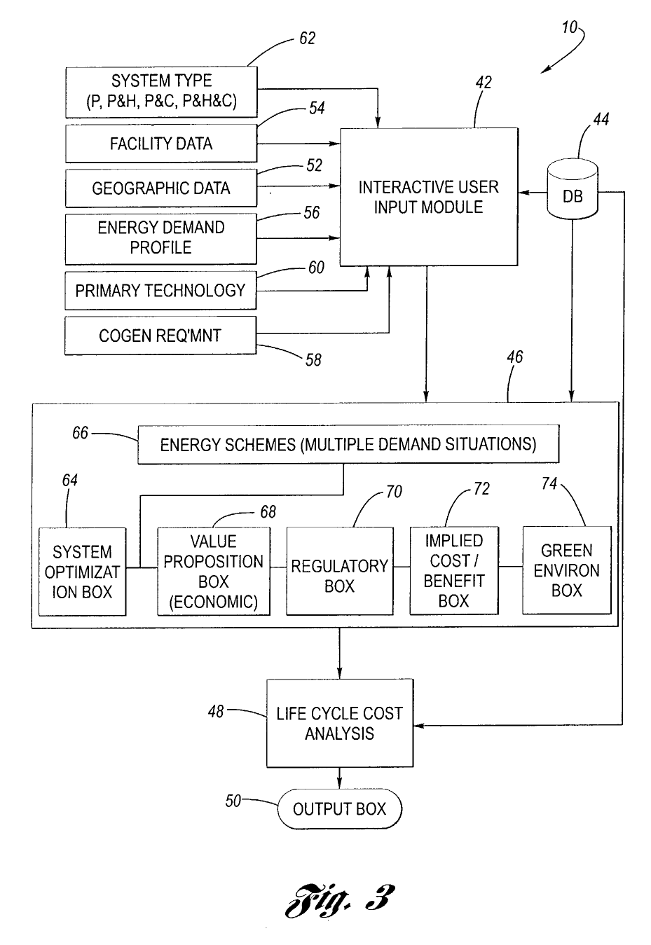

FIG. 2 is a block diagram view showing the architecture of the present invention. In particular, FIG. 2 shows an operating system layer 32, a database (DB) layer 34, an application layer 36, an interface layer 38, and a client portion 40.

Operating system 32 may be, in the case of stand alone system 10, a Microsoft Windows 9x operating system, such as Windows 95/98. Regarding client/server system 10a, and web server system 10b, OS 32 may be a Microsoft Windows NT operating system. It should be understood, however, that although the aforementioned Windows operating systems may be used, that other operating systems may also be used in accordance with the spirit and scope of the present invention, such as, for example, an alternate Microsoft Windows operating system (e.g., Windows 2000, Windows XP, Windows ME), a suitably configured Apple computer operating system (e.g., OS X), or a Linux or Unix operating system.

Database layer 34 is configured to provide a static and dynamic contact structure, and which is used to store both intermediate information while executing the method according to the invention, as well as longer-term storage of various pieces of equipment, regulations, ambient temperatures, and the like. In a constructed embodiment, database layer 34 employs a relational database platform, such as Oracle 8i (or Oracle 8i Lite), a commercially available relational database platform offered by Oracle Corporation, Redwood Shores, Calif., USA.

The application layer 36 is configured to communicate with the database server for all of its database requirements. The application layer 36 is configured to execute in accordance with the functionality described herein. The application layer 36 is further configured to communicate between the user interface 38 and the database layer 34; that is, the communication between the user interface 38 and the database layer 34 occurs through the application layer 36. Application layer 36 may be implemented using conventional software development components, for example, based on COM technology. These components may use Microsoft Visual Basic (VB) 6.0. In addition, application layer 36 may further include a combination of Java Script, VB Script and ASP (Active Server Pages) to provide the necessary dynamics and functionality, again, as described in greater detail herein.

Interface 38 is configured, in a preferred embodiment, to be Hypertext Markup Language (HTML)-compliant. Thus, a client browser, such as client 40 may be used to access the interface 38. Use of an HTML-compliant front-end for interface 38 ensures easy adaptability to web-based operations and also to facilitate a multilevel use in large multi-location organizations. In a constructed embodiment the data/content, which is the output of application layer 36, may be organized into a directory structure on a hard drive, which may then be served up by way of a conventional web server, such as, for example, Microsoft Corporation Personal Web Server (PWS) available from Microsoft Corporation, Redmond, Wash., USA. Client 40 may comprise conventional Internet browsing programs, such as Microsoft Internet Explorer, or Netscape Navigator.

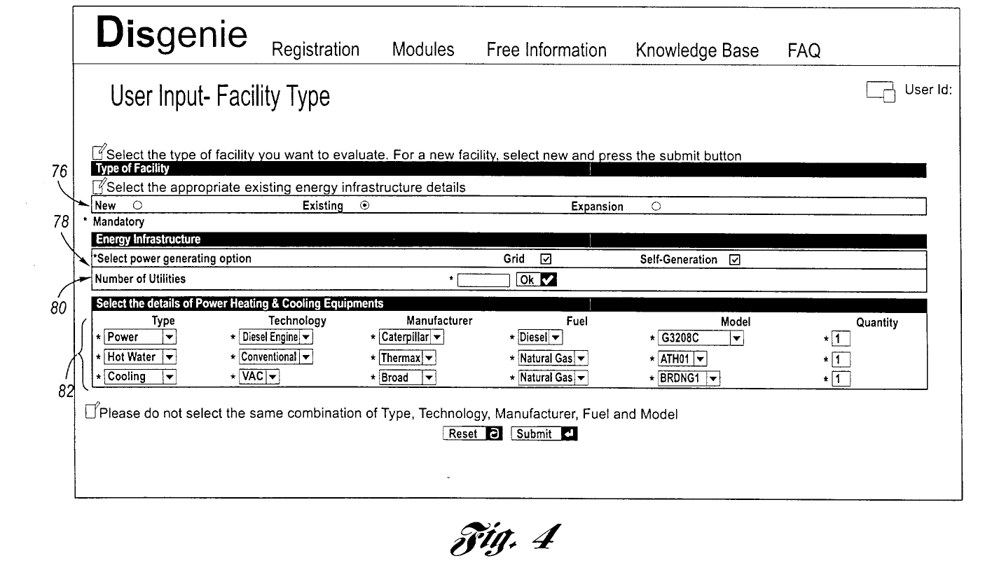

FIG. 3 is a simplified block and flow diagram view of a system and method according to the present invention. FIG. 3 shows a user input module 42 coupled to a database 44 (via the database layer 34, best shown in FIG. 2), a configurator module 46, a life cycle cost analysis (LCCA) module 48, and a final output module 50.

Input. Input module 42 enables a user of the system 10 to capture an energy (i.e., power, heating and cooling) demand profile associated with the facility in all of its complexity (if desired), taking into account factors like quantity and quality of the energy needs, ambient temperature conditions, fuel and power providers in the area, environmental regulations in force, and the like.

System Configurator. Module 48 is configured to map the inputted energy demand profile to a primary technology selected by the user and configures a plurality of energy schemes applicable to multiple energy demand situations.

Value Proposition. A value proposition module, that is a portion of module 46, is configured to provide the primary techno-economic analysis of a selected energy scheme, compared to either (i) the user's existing solution, or (ii) a competing energy scheme (e.g., hypothetical). The value proposition module is further configured to conduct comprehensive benchmarking, taking into account factors like complementary generation options in the event that 100% of the energy demand is not met by the selected energy scheme; the total cost of the selected energy scheme, including cost of essential components like pollution mitigation equipment and supplementary equipment to enhance power quality (complementary, supplementary, and mitigation equipment collectively hereinafter “implied costs”) as well as implied benefits, like production lost that would be saved.

Life Cycle Cost Analysis (LCCA). The LCCA module 48 is configured to provide a complete life cycle cost analysis of the selected energy scheme, which is adapted to estimate future power/fuel costs, the cost of debt, the tax rate and depreciation. The cost parameters are calculated on the basis of different methods like Present Value, Net Present Value, and Discounted Payback. In addition, module 48 is also configured to provide detailed costs based on different financing options like Build, Own, Operate (BOO), term loan and lease, thereby providing high quality information critical for investment decisions.

Referring again to FIG. 3, a variety of input information is shown flowing into input module 42. This input information includes geographic data 52, facility data 54, an energy demand profile 56, a cogeneration requirement (if any) 58, a primary technology 60, and a system type 62. In addition, FIG. 3 shows configurator module 46 as including a system optimization box 64 outputting a plurality of energy schemes 66, a value proposition box 68, a regulatory box 70, an implied cost/benefit box 72, and a green environment box 74. It should be understood that the arrangement of the modules/boxes in configurator 46 does not necessarily indicate an order or sequence in which they are executed, unless so specifically stated in detail herein.

Input module 42 is configured to query and receive general input data, such as the geographic location (country, state or province, and city) which defines geographic data 52, the energy unit system in force (e.g., MKS, FPS, or SI), the preferred currency (e.g., US dollars), the company name, the tax status, and the industry sector (e.g., commercial, residential, etc.). Geographic data 52 is primarily used to select information from database 44 on factors used in calculating an energy scheme, such as prevalent ambient conditions, fuel availability in the area and regulations in force (if any).

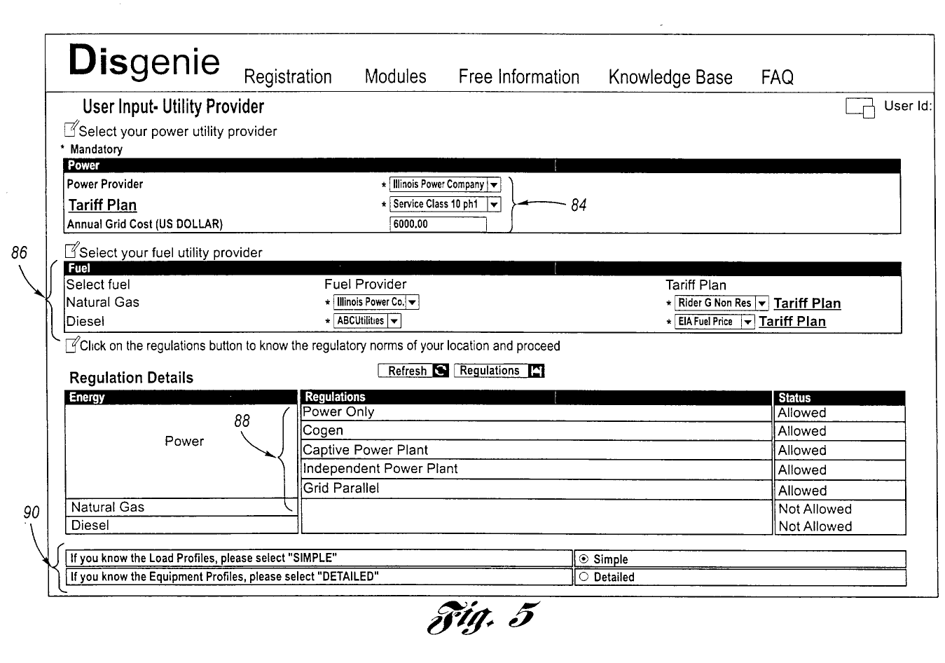

FIG. 4 shows a screen display, produced by input module 42, configured for capturing facility data 54. Broadly speaking, there are three facility types, as follows: (1) a new facility; (2) an existing facility; and (3) an expansion facility. A new facility, for example like a new manufacturing plant or hotel under construction, is a facility where energy needs for the business operations have not yet arisen. In an existing facility, energy needs are being met by power from a power grid and/or power generating equipment already installed in-house, i.e., through self-generation. An expansion type facility is an existing facility that is being expanded. System 10, via input module 42, is configured to provide the user a choice of configuring an energy scheme for only the “new” components of the facility (i.e., the expanded portions) or for both the “new” and “existing” components. In the latter case, the data required is the same as that required for configuring an energy scheme for an existing facility.

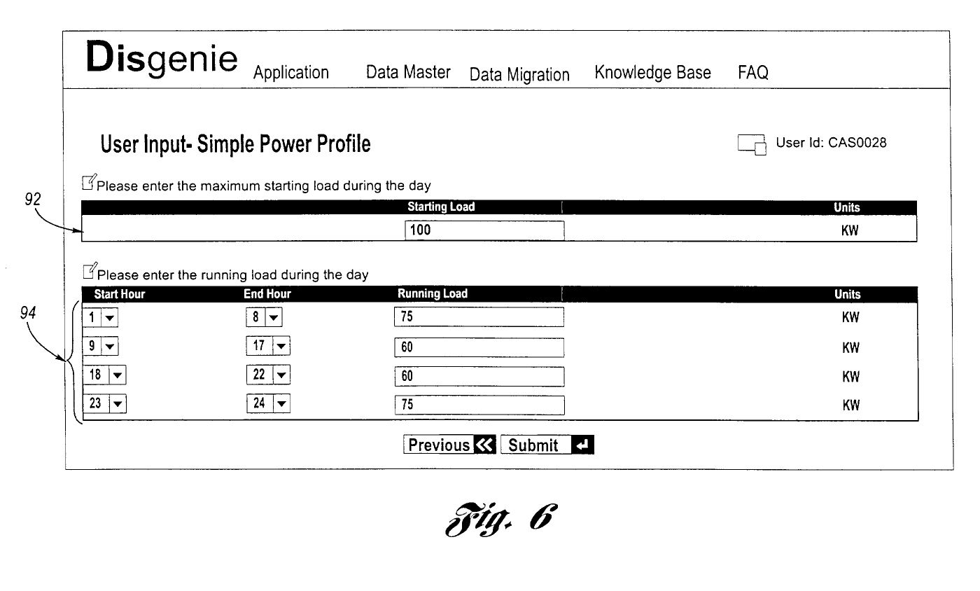

If the user selects the “new” radio button in pane 76 shown in FIG. 4, then control flows to a utility provider's input screen, best shown in FIG. 5.

However, if the user selects the “existing” radio button in pane 76, then the user will be prompted to provide information about the existing energy infrastructure, namely, whether it is provided via grid-provided power only, through self-generation only, or through both grid and self-generation. In the illustrated embodiment, this is done by allowing the user to click on respective check boxes shown in pane 78 of FIG. 4. As shown in FIG. 4, both the grid check box and the self-generation check box are selected. If the user clicks on the self-generation check box, pane 80 will be displayed, which asks for the number of self-generation utilities present in the existing facility energy infrastructure. System 10, by way of input module 42, will generate as many input entries (i.e., rows) as the “number of utilities” indicated by the user in pane 80. These entries are shown in pane 82 of FIG. 4. For each entry, the user will specify details of the equipment being used for generating power, heating and cooling, such as, but not limited to: type, technology, manufacturer, fuel, model, and quantity. These details may be selected from drop down lists based on information contained in database 44. For equipment not already included in database 44, system 10 includes a facility for entering such information by way of a knowledge base (not shown). The foregoing information, collectively defining the facility data 54, is stored in database 44 as intermediate data for further processing.

If the user selects an “expansion” type facility by selecting the “expansion” check box in pane 76, then system 10, by way of input module 42, will ask the user to indicate whether to evaluate only the “new” portions of the expansion, or both the “new” and “existing” portions. If the user chooses to evaluate only the new portions, then control is passed to the utility providers screen (FIG. 5); otherwise, if the user selects to evaluate the new and existing portions of the expansion facility, the user will be guided through the procedures described above for an “existing” facility.

Referring now to FIG. 5, whether a user is generating an energy scheme for a new, existing or expansion-type facility, a grid power provider must be selected who is meeting or could meet the facility's energy demand. The input module 42 displays the power provider for the geographic area by default. A user, however, can specify another power provider for the same area. A user is also prompted to select a tariff plan, as well as enter the fixed annual grid cost, all as shown in pane 84 in FIG. 5.

In addition, if, in the facility type input screen (FIG. 4), the user had entered details for self-generation equipment, then the input module will prompt the user to select one or more fuel providers as well, as shown in pane 86 in FIG. 5. The number and nature of fuel providers depends on the nature and fuel used by the selfgeneration equipment.

Pane 88 shown in FIG. 5 shows details of the regulations in force for the geographic area in which the facility is located. System 10 will use these regulations in generating one or more energy schemes that meet the facility requirements. For example, certain types of equipment and/or self-generation may not be allowed in a geographic area. The inventive system takes these restrictions in account in configuring energy schemes.

Input module 42 then queries the user to select either a “simple” or “detailed” energy demand profile, as shown in pane 90 in FIG. 5. A simple energy demand profile will require the user to input only basic power demand details, while a detailed power demand profile will require the user to input power consumption details of specific pieces of equipment.

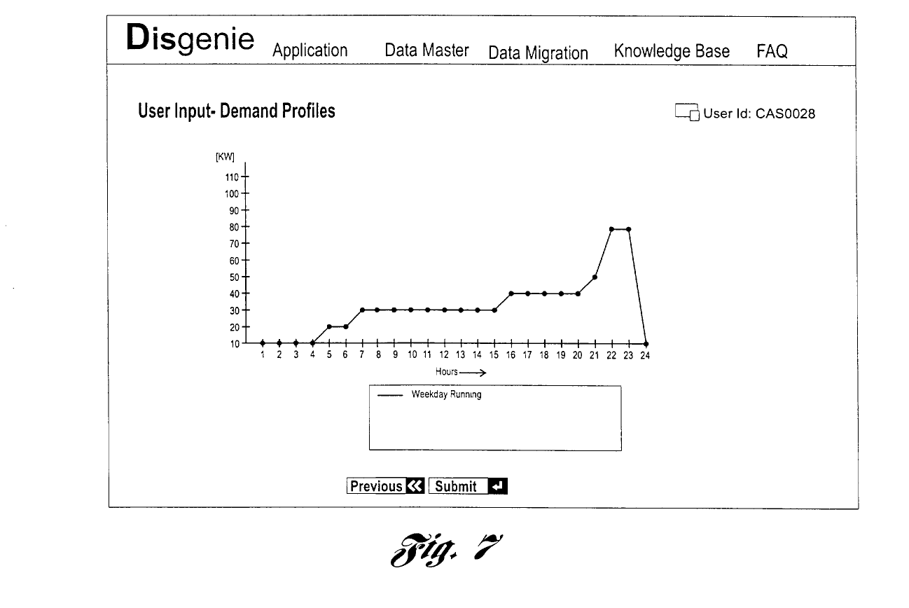

FIG. 6 shows an interface for inputting a simple energy profile (including a power component). In pane 92 of FIG. 6, the user enters a starting load (the maximum starting load during the day), while in pane 94, the running load for the day may be broken up into one hour increments and entered separately for as many intervals as the user wishes to specify for the facility. For example, in FIG. 6, the starting load is 100 kilowatts (maximum), while the running load is 60 kilowatts between 9:00 a.m. and 5:00 p.m. (17 hours). The time dependent energy profile is shown graphically in FIG. 7.

Detailed Demand Profile. When specifying a detailed energy demand profile, a user must specify the particular power consuming equipment associated with the facility under analysis. The equipment may be selected from either a general list (i.e., a list of all power consuming equipment contained in database 44), or from a domain list (i.e., a smaller list of power consuming equipment used typically in the industry sector to which the facility belongs, as self-identified in the general information input stage described above).

Once particular pieces of equipment have been selected (e.g., escalator, Jacuzzi, lamps, motors, pumps, etc.), a power quality characteristic must be defined for each piece. Every power consuming piece of equipment selected needs power of a certain quality, defined in terms of volts (V), hertz (Hz) and total harmonic distortion (THD). Input module 42 will display standard V, Hz and THD requirements of the selected equipment, based on information retrieved from database 44. Input module, however, allows the user to change any of the displayed power quality parameters. It should be understood that the power quality parameters may determine additional investments that must be made in ancillary equipment, like power transformers and control panels, as understood by those of ordinary skill in the art.

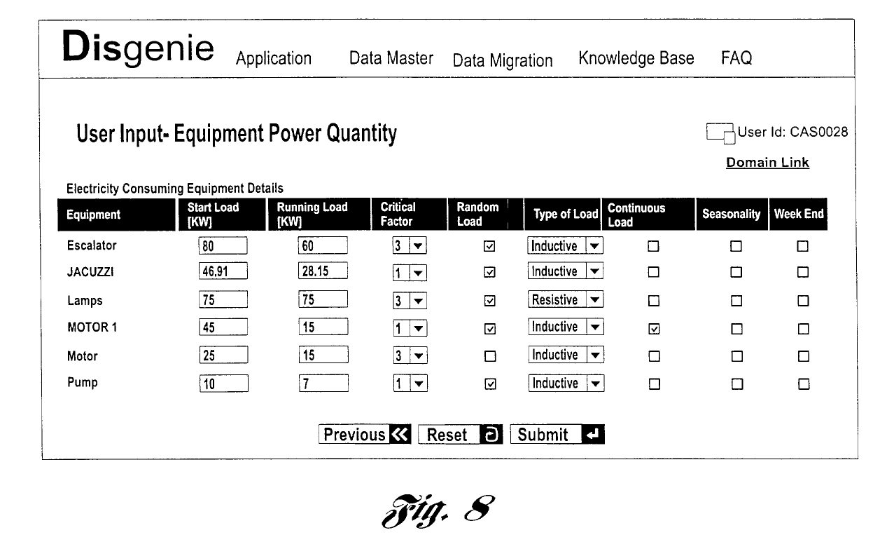

Referring now to FIG. 8, the next step involves specifying power quantity demand. An input screen for this function is shown in FIG. 8. For every power consuming piece of equipment selected, the user will be prompted to specify details of power consumption, in terms of starting load, running load, type of load (i.e., inductive/resistive) and random/continuous load (i.e., whether the equipment is used occasionally or for all 24 hours of the day, whether it is used throughout the year or only seasonally, etc.). The user will also have to specify a critical factor to be associated with the equipment, in an ascending scale of 1 to 3. Equipment with a criticality factor of 3 is taken into account for calculation of a critical starting load and critical running load. As described in detail below, one mode of analysis involves selecting equipment for a critical demand situation. The equipment is sized to meet the loads identified as “critical” loads equal to “3.”

Two other key details must be specified by the user for the detailed demand profile: (1) whether the equipment's power consumption varies according to season (e.g., air conditioners), i.e., it displays seasonality, and (2) whether power consumption drops during weekends (e.g., for air conditioners used in an office complex closed during the weekend). This information is stored as intermediate data in database 44.

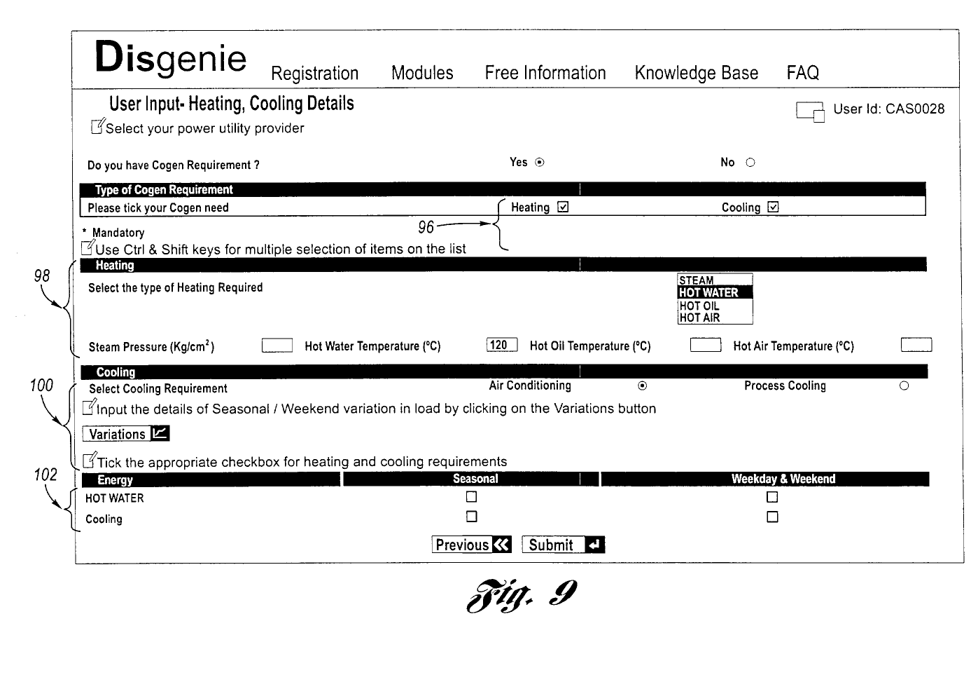

FIG. 9 is an input screen configured to obtain cogeneration requirements 58 (best shown in FIG. 3). Once the power/load profile has been established (either through the simple method, or the detailed method), input module 42 is configured to query whether the facility is to be equipped with cogeneration equipment. If the user selects the YES radio button, the user will then specify the cogeneration need by either clicking the heating check box, the cooling check box, or both check boxes, as shown in pane 96 in FIG. 9. System 10 will then display fields so as to allow the user to specify details of the heating and/or cooling requirements, as shown in panes 98 (heating) and 100 (cooling). Note, that multiple heating requirements may be selected in pane 98 by using, for example, the shift and control keys, as commonly known in any Microsoft Windows compliant software program. Pane 102 allows the user to specify whether there are seasonal and/or weekend and weekday variations in the cogeneration demand.

Once the user selects the “submit” button in FIG. 9, the user is prompted to provide additional cogeneration requirement details (input display screen not shown). These additional details include specifying the hourly variation in the demand for heating and cooling in a manner similar to that described above for specifying a simple power demand profile. The combination of the power component (electrical load) demand in combination with any heating and/or cooling (cogeneration) demand is collectively referred to herein as the composite energy demand profile 56 (best shown in FIG. 3), which is stored as intermediate data in database 44.

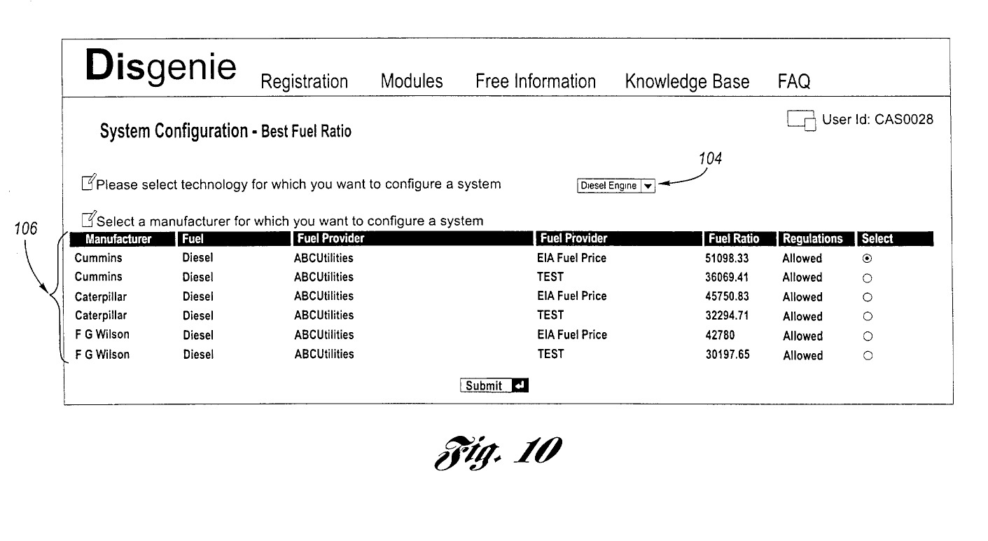

FIG. 10 is a screen display generated by input module 42 for soliciting a primary technology option 60. After the user has selected/input data based on the energy demand profile for the facility, the user must also specify the primary technology option on which the energy scheme to be configured should be based. First, the user selects a basic technology at pull down menu 104, for example, diesel engine, gas engine, microturbine, or the like. The drop down list will display only technologies permitted by local regulations. System 10 by way of module 42, will then display details of equipment options that can meet the demand for the facility as shown in pane 106. The options shown in pane 106 are based on the fuels available at the facility's geographic location. Details such as manufacturer name, fuel type, fuel provider, tariff plans, fuel ratio, and regulations (i.e., whether the option is allowed or not allowed in a particular location) are also displayed. System 10, by default, selects the option that exhibits the best fuel ratio, calculated on the basis of fuel price compared to equipment efficiency, drawing from information contained in database 44. This choice is advisory, however, as the user can choose any one of the displayed options as the primary technology option. System 10 even allows a user to choose an option that is “not allowed” under prevailing regulations (viz., if the user knows that the option will be allowed at the time of implementation of the energy scheme).

Next, system 10, by way of input module 42, will display (not shown in the Figures) possible system types (i.e., power generation options). The system type parameter is indicative of the type of equipment to be included in the energy scheme. The system will determine the possible system types based on the energy demand profile 56 and the selected primary technology 60. For example, possible system types include “power only,” “power & cooling,” “power & heating,” “power & heating & cooling.” The user is provided the means to select one of the displayed system type options. The selection is hereinafter referred to as the selected system type 62.

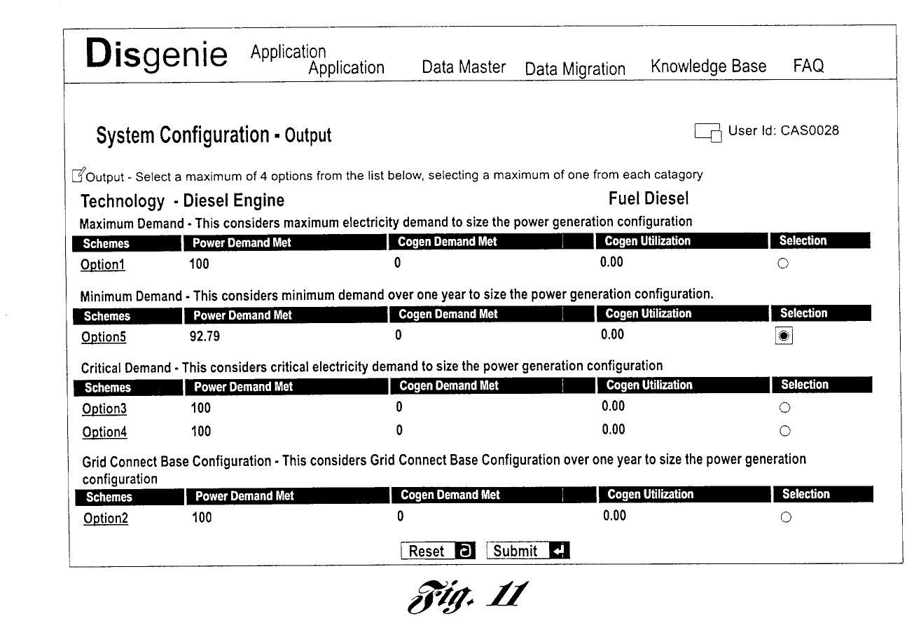

FIG. 11 is a screen display showing a plurality of output energy schemes for multiple demand situations. This is the initial output of the system 10. The system will configure a detailed energy scheme of the type chosen as system type 62, taking into account all relevant factors such as ambient conditions of the geographic location data 52, the energy demand profile 56, cogen requirements 58, the fuel and technology availability in the location, and the regulations in force. System 10 is configured to provide a primary emphasis as to the required power demand when configuring an energy scheme. Detailed energy schemes (i.e., equipment configurations) will be established by system 10 for a plurality of demand situations. Exemplary demand situations include a maximum demand situation, a minimum demand situation, a critical demand situation, an optimal demand situation, a cogeneration demand situation, and a grid parallel-based demand situation. The maximum demand situation is an arrangement that considers the maximum electricity demand of the facility in sizing the power generation equipment. The minimum demand situation is an arrangement that considers the minimum demand of the facility over one year to size the power generation equipment. The critical demand situation is an arrangement that considers the critical electricity demand of the specified electrical loads of the facility in order to size the power generation equipment (i.e., specifying a critical factor of 3 for the equipment in FIG. 8). The optimal demand situation is an option that selects the power generating equipment that ensures the most optimal yearly efficiency and maximum utilization. The cogeneration demand situation is an option that selects the power generation configuration based on the cogeneration required and the power demand curve. The grid parallel-based demand situation is an arrangement that considers the grid connect base configuration over one year to size the power generation equipment.

System 10 is further configured so that the demand situations will be selected according to the specifications of the primary technology selected by the user. For instance, if the equipment technology selected (i.e., the primary technology 60) cannot meet the facility's full power demand, an energy scheme will be worked out by system 10 for the minimum demand situation and the critical demand situation. If the system type 62 selected by the user is “power and cooling,” and the primary technology 60 selected by the user can meet the user's optimal and cogeneration demand, then energy schemes for both of these demand situations will also be worked out. Moreover, if the user has defined a requirement as a combination of grid power and self-generation, system 10 will further work out an energy scheme for the grid parallel-based demand situation.

Referring again to FIG. 11, five exemplary options configured for and corresponding to the four displayed demand situations are shown. The display shown in FIG. 11 is in the nature of an overview snapshot, and includes information such as percentage of power demand met, percentage of cogeneration demand met, and cogeneration utilization. The display in FIG. 11 is configured so that the user may select (click) on one of the energy schemes in order to “drill down” and obtain a detailed view of its makeup.

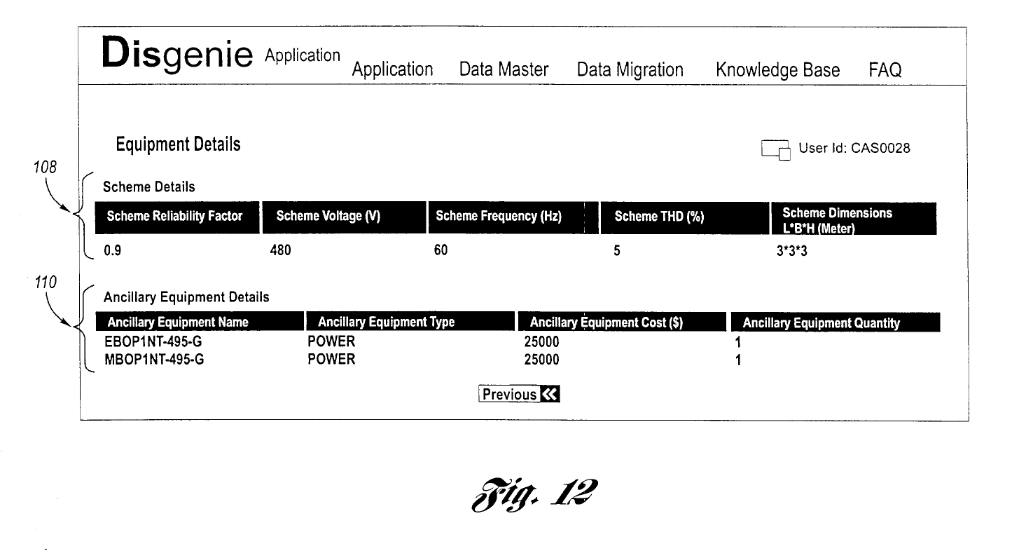

FIG. 12 shows a sample of such a detailed view, for example, of “option 1” under the “maximum demand” category of FIG. 11. Pane 108 shows energy scheme details, including a scheme reliability factor, a scheme voltage, a scheme frequency, a scheme total harmonic distortion (THD) (%), and a scheme physical dimension parameter. The scheme reliability factor is a numerical value in the range of between about 0.8 to 1.0. The scheme reliability factor indicates the overall proportion of time the equipment is likely to generate power, and is based on industry records. As described in greater detail below, the reliability factor may influence whether standby options are included in the overall system, for example extra equipment or grid power. Pane 110 shows the ancillary equipment details including the equipment name and type, its cost and quantity.

Referring again to FIG. 11, a user may select up to four energy schemes for detailed economic analysis (although only one scheme is shown as being selected in FIG. 11, namely “option 5”). System 10 then proceeds to conduct an economic analysis and generate a value proposition output. System 10 queries the user as to whether a simple or comprehensive analysis is to be performed. A “simple” analysis works out the difference between the operating cost of the selected energy schemes (from FIG. 11) and the user's existing scheme to give a simple investment payback calculation. In the case of a new facility type, the grid option is considered the “existing” scheme. A comprehensive analysis, on the other hand, gives the same results as the simple analysis with additional data to compare the selected energy schemes with a competitive energy scheme based on the same (or different) technology.

After selecting one or more energy schemes for analysis (from FIG. 11), the user is asked to select either a “simple” or “comprehensive” analysis. If the user has opted for a “simple” analysis, and there is an unmet demand component, then the user will be required to select complementing technology to meet the balance demand, and control will thereafter flow to the implied cost/benefit box 72. If the user has opted for a simple analysis and there is no unmet demand component, then control will flow to the implied cost/benefit box 72 (best shown in FIG. 3) for inputting implied costs, which will be described in greater detail below.

On the other hand, when the user has opted for a comprehensive analysis, the user is prompted to select a competing technology (with reference to the selected primary technology 60). A screen display (not shown) is generated that will allow a user to select both a basic technology (e.g., diesel engine, gas engine, etc.) and a corresponding manufacturer of equipment. Again, if there is an unmet demand component, the user will be prompted to select complementing equipment to meet whatever the unmet demand component is (e.g., whether it be power generation, heating or cooling). In either case, control will flow to the implied cost/benefit module 72.

Implied Costs/Benefits. The implied cost/benefit box 72 in FIG. 3 reflects the notion that any energy scheme usually involves additional equipment like (1) standby power supply equipment, (2) supplementary equipment to bring power up to a predetermined desired quality, and (3) mitigating equipment to bring down various kinds of pollutants to permissible limits. Investment in this additional equipment comprises an implied cost of the energy scheme. Financial comparison of different energy schemes becomes more meaningful when the implied cost of each energy scheme is taken into account. Hence, a user may have to select standby, supplementary, or mitigating equipment, as the case may be, for each of the selected energy schemes. If a user has selected a “comprehensive” economic analysis, a user is prompted to select standby, supplementary, and mitigating equipment for both the primary and competing energy schemes.

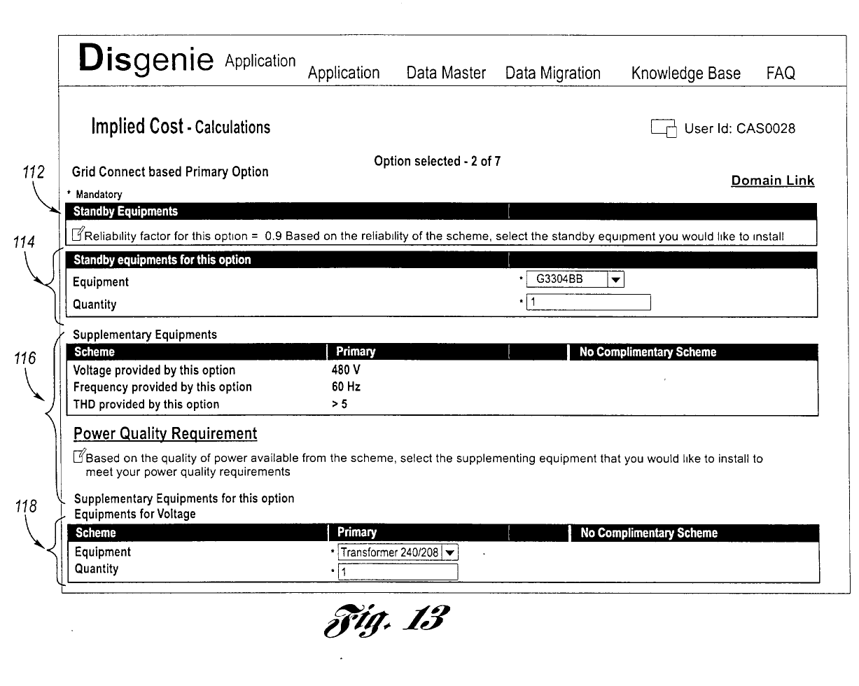

Referring now to FIG. 13, pane 112 provides information as to the reliability of the energy scheme presently under consideration. Pane 114 provides an interface through which the user can select equipment and specify the quantity thereof, taking the reliability factor into account. Pane 116 displays the quality of power that will be provided by the energy scheme and the quality of power needed at the facility being configured. Pane 118 provides an interface in which the user can select equipment and specify the quantity thereof. The user can use the displayed information in selecting supplementary equipment. In addition, system 10 will display (although not shown in the figures) pollution generation parameters for the energy scheme that are beyond permissible limits, based on regulations and the like for the geographic area in which the facility is located. For instance, if SO_{X} emission of the energy scheme is within permissible limits, equipment for bringing this emission down to permissible limits need not and thus will not be displayed. Additionally, space cost (i.e., cost per square meter of land in the user's location) will be solicited and used in the economic analysis. Flow then proceeds to an implied benefit input interface.

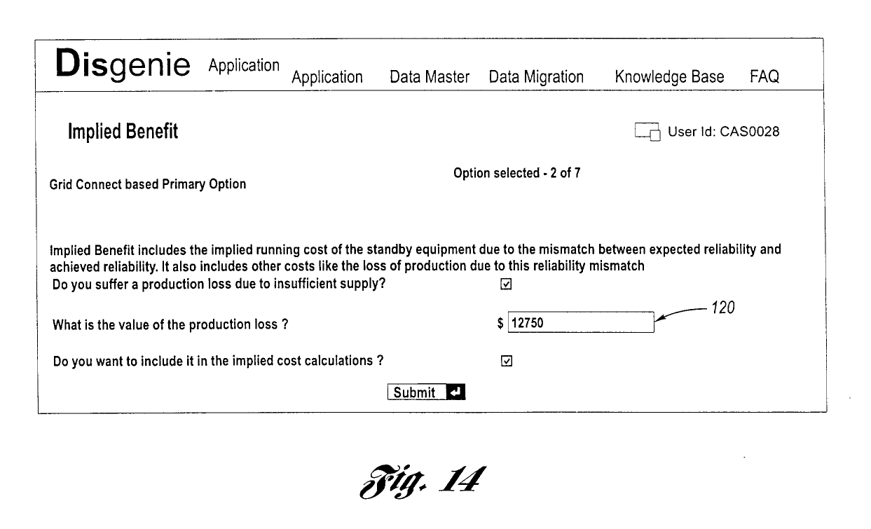

FIG. 14 shows an implied benefit display. The economic calculations can include implied benefits, understood as the production loss that would be suffered due to insufficient power supply, and hence would be avoided (i.e., benefit) if standby equipment or grid is added to the energy scheme. In most cases there would be a significant production loss if the reliability factor of the primary technology equipment is less than 1. The higher the reliability factor, the lower the potential loss of production and vice versa. The interface allows the user to estimate a value of production that would be lost due to insufficient power, and factor that value in the investment decision. The estimated value is shown entered in input box 120. Flow then proceeds to the generation of a value proposition output.

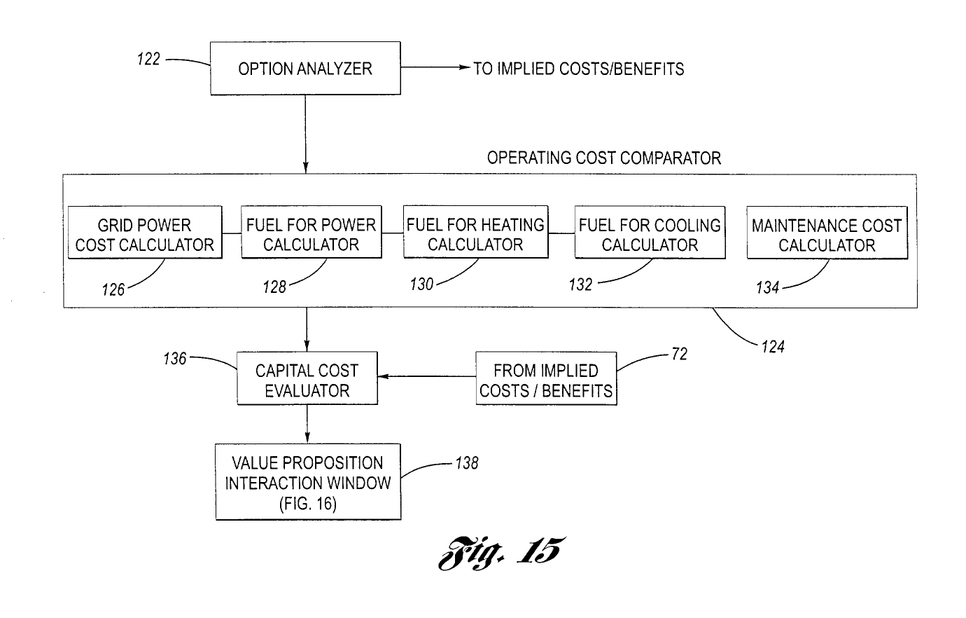

FIG. 15 is a simplified block and flow diagram showing how the value proposition box 68 determines its outputs, for example, capital cost and operating cost parameters for both the primary and competing energy schemes for all applicable demand situations. The total operating cost is determined by an operating cost comparator 124 and reflects the total annual operating cost of all the energy generating equipment (including complementary equipment, if any) as well as the cost of all standby/supplementary/mitigating equipment. Comparator 124 calculates the annual operating cost on the basis of the energy demand profile for the facility, applicable fuel/grid tariff plans, as well as estimates of maintenance costs, which are derived from the equipment's reliability factor, all as shown in boxes 126, 128, 130, 132 and 134.

The capital cost evaluator 136 determines the total capital cost for the energy scheme. This parameter is calculated based on the current cost of the energy generating equipment (power, and heating and/or cooling equipment) and includes any complementary equipment, if needed, as well as the “implied cost” (i.e., the current capital cost of all standby, supplementary, mitigating equipment). As shown in FIG. 15, the implied costs are taken as an input from the implied costs/benefits box 72, as described above. An output display is then generated.

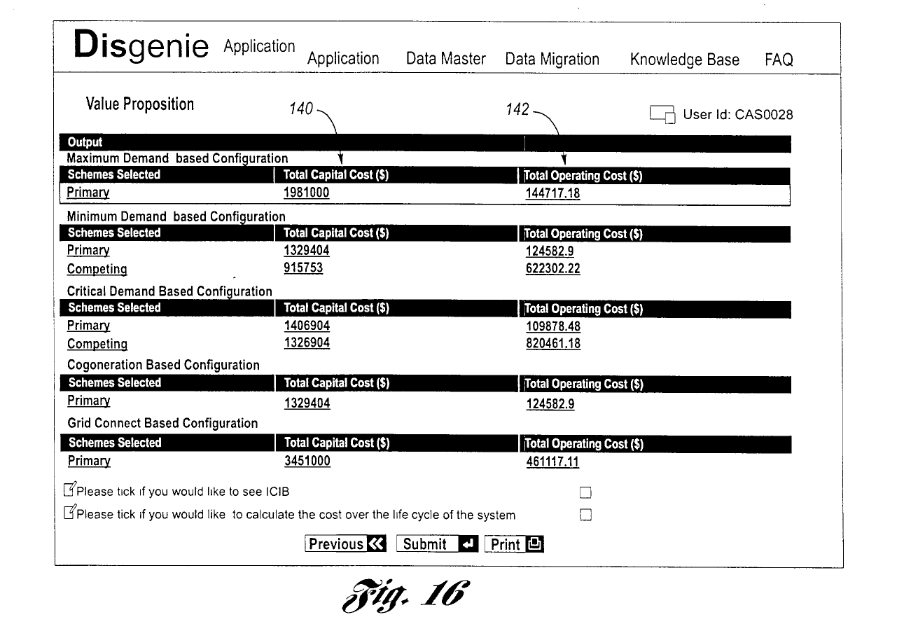

FIG. 16 is a display of such a value proposition output. As shown, for each of the plurality of different demand situations, each energy scheme includes a respective total capital cost, as arranged in column 140, and a total annual operating cost, as arranged in column 142. Clicking on the energy schemes (e.g., the “primary” scheme under the “maximum demand” category) will drill down and provide details of the scheme like technology, manufacturer, fuel, model and quantity of the total equipment (i.e., the primary equipment, any complementary equipment, any standby equipment, any supplementary equipment and any mitigating equipment). In a like manner, clicking on the hyperlinks under each of the cost components will drill down into a detail view that shows the break-down of the selected economic parameter.

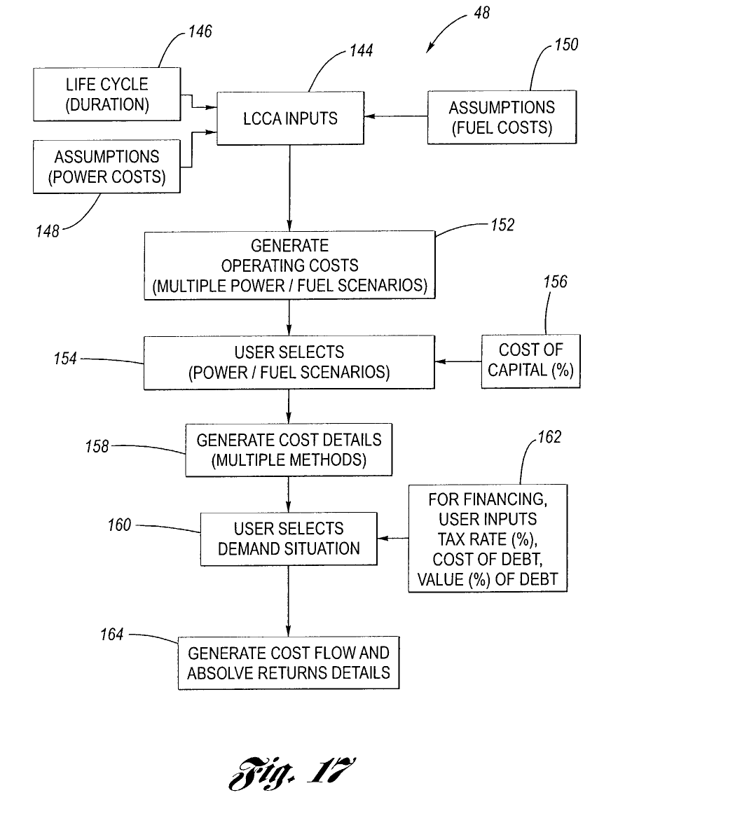

FIG. 17 is a flow diagram showing, in greater detail, the flow of the life cycle cost analysis module 48 (best shown in FIG. 3). The life cycle cost analysis module is configured to generate a plurality of outputs, including (1) an operating cost output (for multiple power/fuel scenarios), (2) a cost detail output (for multiple cost calculation methods), as well as (3) a cost flow and absolute return output.

Referring again to FIG. 17, execution of the life cycle cost analysis module begins with obtaining a variety of inputs from the user, as shown by box 144. One input is the user's estimate of the life cycle (i.e., duration) of the useful equipment life for the equipment primary energy scheme, as shown in box 146. The user may specify the lowest life cycle figure in order to obtain the most cons. For example, if the energy scheme includes heating, cooling and power generation equipment, the life cycle that may be entered (i.e., in years) is that of the piece of equipment that is likely to have the lowest life cycle (duration).

In addition, the user enters estimates, in the nature of forecasts, of the expected rise/fall in the costs of both power and fuel, as shown by boxes 148 and 150. System 10, by way of module 48, provides the option of forecasting both aggressively and conservatively. The analysis module generates outputs under both the conservative and aggressive scenarios. For example, a rise of around 2% in fuel costs every year may be considered a “conservative” estimate, with a rise of around 4-6% may be considered an “aggressive” estimate. In one embodiment, input box 144, by way of access to database 44, retrieves information on past trends for both power and fuel and provides these to the user by the way of links to help the user in forecasting the rise in power/fuel costs. The flow then proceeds to box 152.

In box 152, the LCCA module 48 generates the operating cost over the life cycle of the energy scheme for the plurality of different conservative/aggressive power/fuel scenarios. That is, one scenario is an aggressive increase in both power and fuel, another is a conservative increase in both power and fuel, another is an aggressive power increase coupled with a conservative increase in fuel, and a final scenario is a conservative increase in power with an aggressive increase in fuel costs. The operating costs over the life cycle are provided in a screen display (not shown) for both the primary energy scheme, and the competing energy scheme (both user selected) over multiple demand situations (e.g., maximum demand, minimum demand, etc.). The flow then proceeds to box 154.

In box 154, the user may select a particular power/fuel scenario (e.g., conservative power, and aggressive fuel cost increases). In addition, module 48 queries the user for an estimate of the cost of capital, in percent. This input is shown as box 156. Flow then proceeds to box 158.

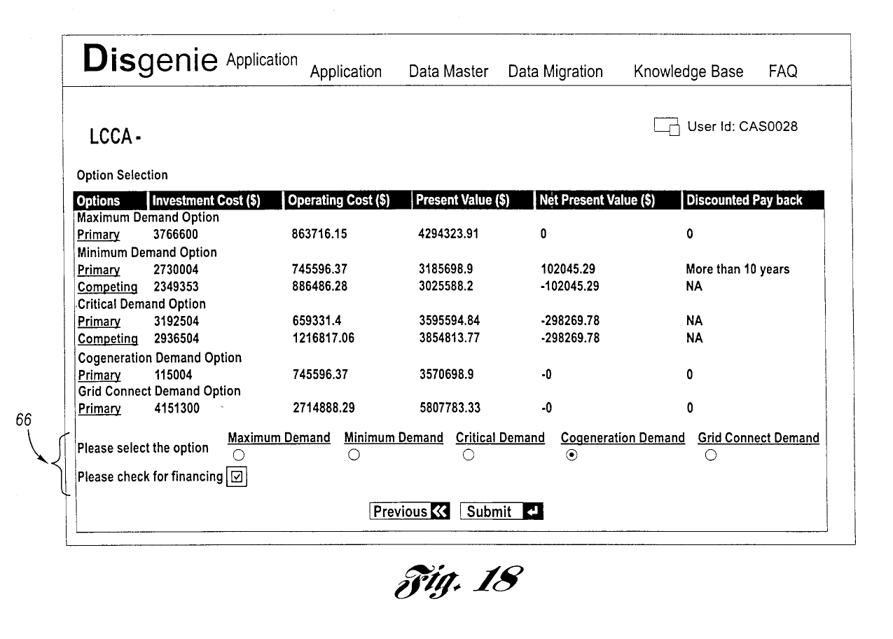

In box 158, module 48 generates a cost detail of both the primary/competing energy schemes on the basis of different calculation methods, such as present value (PV), net present value (NPV) and discounted pay back period. An exemplary output screen of the life cycle cost details output is shown in FIG. 18. The formulas for determining present value, net present value, discounted pay back, and other economic figures of merit are well understood by those of ordinary skill in the art, and need not be described in detail herein. The flow then proceeds to box 160.

In box 160, the user may wish to generate cost flow and absolute returns figures of merit. Accordingly, in box 160, the user is prompted to select a demand situation for cost flow analysis. Optionally, the user may click a check box if financing is needed. These selections are both as shown in pane 166 in FIG. 18. If financing is needed, module 48 obtains the information shown in box 162, namely a tax rate (%), a cost of debt, and a value (%) of debt. The flow then proceeds to box 164.

In box 164, module 48 generates cost flow and absolute returns details (not shown). These include a year-by-year breakdown of cash flows and absolute return details (e.g., pay back on capital, remaining balance principal, interest, tax cover on interest, tax cover in depreciation, principal repaid, total repayment per year, actual cash flow, and the like, all on a year-by-year basis). In addition, in box 164, module 48 outputs a power, heating, and/or cooling unit cost on a year-by-year basis over the life cycle selected by the user. The unit cost may be compared to, for example, grid power rates. The economic equations involved in calculating these economic cash flows are well understood by those of ordinary skill in the art and need not be described in detail herein.

Finally, as shown in FIG. 3, the inventive method proceeds to final output box 50. System 10 provides a range of ready-to-print outputs including any of the outputs previously described herein.

In addition, it should be understood that any of the outputs described herein (e.g., energy scheme details, value proposition outputs, etc.) is defined by certain data. The system, particularly, the interface layer 38, formats the data according to a conventional HTML format. A web server, as described above, may transmit this formatted data to a remote client browser, according to a hypertext transfer protocol (HTTP), all as well understood in the art.

The present invention overcomes many of the shortcomings associated with conventional, manual methods described in the Background.

1. A method of determining an energy scheme comprising the steps of:
(A) inputting an energy demand profile for a facility that includes at least a power component;
(B) selecting system type; and
(C) determining at least one energy scheme using the energy demand profile in accordance with the selected system type.

2. The method of claim 1 wherein the energy demand profile includes a cogeneration requirement.

3. The method of claim 1 wherein the system type is a power generation option selected from the group comprising (i) power; (ii) power and heating; (iii) power and cooling; and (iv) power, heating and cooling.

4. The method of claim 1 wherein said at least one energy scheme corresponds to one of a plurality of demand situations comprising (i) maximum demand, (ii) minimum demand, (iii) critical demand, (iv) optimal demand, (v) cogeneration demand, and (vi) grid parallel based demand.

5. The method of claim 1 wherein said determining step includes the substep of calculating a plurality of energy schemes corresponding to a plurality of said demand situations.

6. The method of claim 4 further comprising the step of selecting a primary technology, wherein the energy scheme is further determined based on the selected primary technology.

7. The method of claim 6 further comprising the step of selecting a geographical location for the facility.

8. The method of claim 7 further comprising the step of associating ambient temperatures and fuel availability with the selected geographic location, wherein the energy scheme is further determined based on the ambient temperatures and fuel availability.

9. The method of claim 8 further comprising the step of associating a set of regulations with the selected geographic location, wherein the energy scheme is further determined based on the regulations.

10. The method of claim 6 wherein said energy scheme is a primary energy scheme, said method further comprising the steps of:
selecting a competing technology;
determining a competing energy scheme according to the selected competing technology;
calculating a value proposition output including total capital cost and total operating cost parameters for the primary and competing energy schemes.

11. The method of claim 10 further including the step of inputting implied costs associated with each of the primary and competing energy schemes and wherein said step of calculating said value proposition output is further calculated using the implied costs.

12. The method of claim 11 wherein said step of inputting implied costs includes at least one of the substeps selected from the group comprising:
selecting a standby option associated with at least one of the primary and competing energy schemes;
selecting a supplementary option associated with at least one of the primary and competing energy schemes; and
selecting a mitigation option associated with at least one of the primary and competing energy schemes.

13. The method of claim 12 wherein said step of selecting the standby option is performed based on a reliability parameter associated with equipment included in said primary energy scheme.

14. The method of claim 12 wherein said step of selecting the supplementary option is performed based on a quality of power parameter associated with equipment included in said primary energy scheme.

15. The method of claim 12 wherein said step of selecting the mitigation option is performed based on a pollutant emission parameter associated with equipment included in the primary energy scheme.

16. The method of claim 10 further comprising the step of:
determining a life cycle cost of the primary energy scheme wherein the life cycle cost includes at least one of a capital cost parameter, an operating cost parameter and a cost flow parameter.

17. The method of claim 10 further including the step of transmitting data corresponding to said determined primary energy scheme and said value proposition output from a server computer over a network to a remote client computer.

18. The method of claim 17 further including the step of formatting the data in accordance with a hypertext markup language (HTML).

19. A method of determining a primary energy scheme comprising the steps of:
(A) selecting a geographic location for a facility;
(B) inputting an energy demand profile as a function of time for the facility that includes at least a power demand component;
(C) selecting a primary technology for the primary energy scheme;
(D) selecting a system type indicative of a type of equipment to be configured, the type being selected from the group comprising (i) power; (ii) power and heating; (iii) power and cooling; and (iv) power, heating and cooling; and
(E) determining the primary energy scheme based on the selected geographic location, the energy demand profile, the selected primary technology, and the selected system type.

20. The method of claim 19 wherein the energy scheme is determined for at least one of a plurality of energy demand situations comprising (i) maximum demand, (ii) minimum demand, (iii) critical demand, (iv) optimal demand, (v) cogeneration demand, and (vi) grid parallel based demand.

21. The method of claim 20 further including the step of inputting implied costs associated with the primary energy scheme.

22. The method of claim 21 said method further comprising the steps of:
selecting a competing technology;
determining a competing energy scheme according to the selected competing technology;
calculating a value proposition output including total capital cost and total operating cost parameters for the primary and competing energy schemes based on at least the implied costs.

23. An apparatus for determining an energy scheme comprising:
a computer;
a database associated with said computer configured to store equipment information;
said computer being configured to allow a user (i) to select a geographic location for a facility; (ii) to input an energy demand profile as a function of time for the facility that includes at least a power demand component; (iii) to select a primary technology for the primary energy scheme; and (iv) to select a system type indicative of a type of equipment to be configured, the option being selected from the group comprising (a) power; (b) power and heating; (c) power and cooling; and (d) power, heating and cooling;
said computer being further configured to determine the primary energy scheme using the equipment information based on the selected geographic location, the energy demand profile, the selected primary technology, and the selected system type.

24. The apparatus of claim 23 wherein said computer further includes a server portion configured to format data corresponding to said determined energy scheme in accordance with a hypertext markup language (HTML), said server portion being responsive to requests from a remote client over a network to transmit said formatted data to said remote client according to a hypertext transfer protocol (HTTP).
